(19) United States
(12) Patent Application Publication
(10) Pub. No.: US 2004/0006556 A1
(43) Pub. Date: Jan. 8, 2004

(54) Visual presentation of information in multiple dimensions

(76) Inventor: Daniel Kwoh, Pasadena, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/465,287

(22) Filed: Jun. 18, 2003

Related U.S. Application Data
(60) Provisional application No. 60/389,588, filed on Jun. 18, 2002.

(51) Int. Cl. G06F 7/00

(52) U.S. Cl. 707/1

(57) ABSTRACT

A method for using a computer to search for various travel-related products based on desired travel product attributes inputted by a user and displaying the results of the search in a multi-dimensional table, so that at least one of the parameters of the table is determined by the desired travel product attributes selected by the user.

### CROSS-REFERENCE TO RELATED APPLICATION(S)

The present application claims priority of U.S. Provisional Patent Application No. 60/389,588, filed on Jun. 18, 2002, entitled VISUAL PRESENTATION OF INFORMATION IN MULTIPLE DIMENSIONS, the entire contents of which are hereby incorporated herein by reference.

### BACKGROUND OF THE INVENTION

The present invention is directed to an informational display, and more particularly to a multidimensional information display for comparing products.

In the travel industry, the prices of products, such as airline tickets, hotel rooms, cruises, rental cars, etc., change continuously depending on various conditions. For example, the prices are lower for cruise tickets when the tickets are booked many months in advance. As the sailing date get closer, the ticket prices increase. Usually, the maximum prices occur about four months before the sailing date. This is an optimum length of time for vacationers to plan for their vacations. As the time gets closer to the sailing date, the cruise companies start to worry about unfilled cabins. As a result, cruise operators will lower the prices to attract more bookings depending on the number of cabins left. If there are still cabins available a couple of weeks before the sailing date, then the cruise operator will often discount the tickets by a large amount to promote sales. At this stage, the cruise operator is considering adding a small profit to the marginal cost of an extra passenger.

The ticket prices on cruises also depend on several other factors, such as cruise location, weekends, holidays, months of the year, etc. As a result, in order to shop for a bargain, the vacationer has to go through many trips to travel agencies, or visit many cruise related websites on the Internet. The vacationer has to look into many cruises, one by one, to find the best available deals. This is often a very time consuming process and usually incomplete.

An example of comparison shopping on the Internet, is to compare features of two or more travel products. From a list of available products, the user may choose two or more available products. A table is generated in which each product occupies a column and each row contains a feature of the product so that the user can compare each feature side-by-side. The price or range of prices for each product occupies a row n the comparison table. Thus, this type of display does not allow comparison of prices of more than a few products at the same time.

Another example of travel product comparison on the Internet is airline ticket bookings. After a user enters the required information, the search engine produces a list of itineraries with prices attached to each itinerary. A user may choose to sort the itineraries by price, time, or other attributes. The generated list may be very long depending on the parameter ranges input by the user. Comparison of prices based on a few critical criteria is not possible. The same type of comparison problems exist for other types of products, such as electronic goods.

Therefore, there exists a need for a product presentation method where multiple offerings of a product are displayed in such a manner that a user may grasp and be able to identify the best deal from the displayed information on the screen.

### SUMMARY OF THE INVENTION

A computer and a method utilizing a computer for locating travel products for a user comprising receiving by the computer of desired travel product attributes from a user, searching a database of travel products to select desired travel products using the desired travel product attributes received from the user, and displaying the travel products selected to the user in a multi-dimensional table wherein at least one of the parameters displayed on at least of the axis of the multi-dimensional table is determined by at least one of the desired travel product attributes.

### BRIEF DESCRIPTION OF THE DRAWINGS

These and other features and advantages of the present invention will be better understood by reference to the following detailed description when considered in conjunction with the accompanying drawings wherein:

FIG. 1 is a block diagram showing the relationship of parts of a system for visually presenting information in multiple dimensions in accordance with an embodiment of the present invention;

FIG. 2 is a block diagram of a system for visually presenting information in multiple dimensions in accordance with an embodiment of the present invention;

FIG. 3 shows the contents of a database of cruise products according to an embodiment of the present invention;

FIG. 4 is a flowchart for use of a system for visually presenting information in multiple dimensions according to an exemplary embodiment of the present invention;

FIG. 5 shows a multiple dimension display of cruise products according to an embodiment of the present invention;

FIG. 6 shows the contents of a database of television products according to an embodiment of the present invention;

FIG. 7 shows a multiple dimension display of television products according to an embodiment of the present invention;

FIG. 8 shows a multiple dimension display of airplane tickets according to an embodiment of the present invention;

FIG. 9 shows a multiple dimension display of houses according to an embodiment of the present invention;

FIG. 10 shows a multiple dimension display of digital cameras according to an embodiment of the present invention;

FIG. 11 shows a multiple dimension display of cruise products showing ranges of prices according to an embodiment of the present invention;

FIG. 12 shows a multiple dimension display of cruise products where additional product attributes are being selected according to an embodiment of the present invention;

FIG. 13 shows a sublevel display of cruise products where several criteria have been selected according to an embodiment of the present invention; and

FIG. 14 is a flowchart for purchasing products according to an embodiment of the present invention.

### DETAILED DESCRIPTION OF THE INVENTION

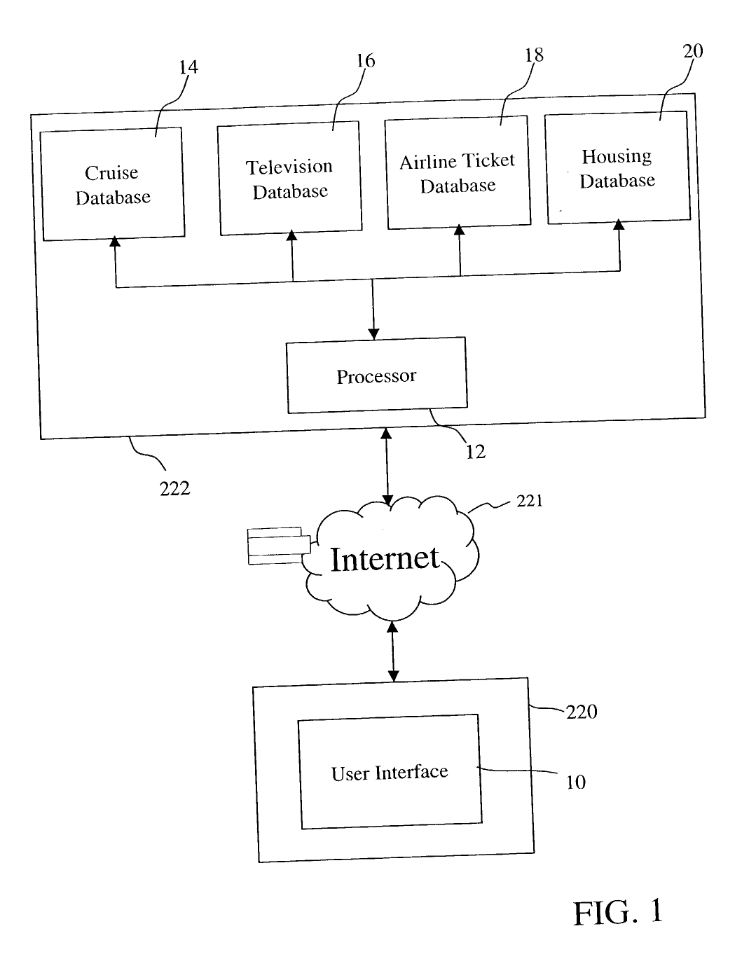

An overview of an embodiment of the present invention is shown in FIG. 1. The system functions between a user device 220 and a server 222 communicating through the Internet 221. The server communicates a user interface 10 to the user device. The user is prompted to enter desired product attributes through the user interface. The user device is coupled to a processor 12 within the server. The processor is in turn linked to a plurality of product databases. For example, the processor may be linked to a cruise product database 14, a television product database 16, an airline ticket database 18 and a housing database 20. Once desired product attributes are entered into the user interface 10 by a user, the user device communicates with the processor 12. The processor searches the product databases to select products having the desired product attributes. Selected products are sent to the user device and displayed in a multiple dimensions.

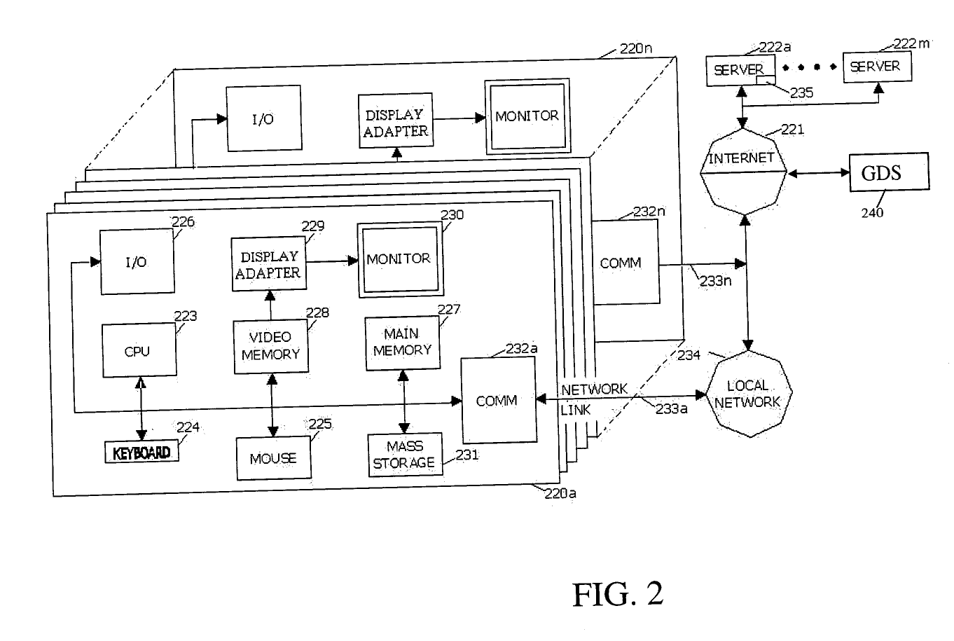

FIG. 2 shows a block diagram of a typical Internet client/server environment used by the users and servers in one embodiment of the present invention. User devices 220a-220n used by the users are connected to the Internet 221 through communication links 233a-233n. Optionally, a local network 234 may serve as the connection between some of the user devices 220a-220n, such as the user device 220a and the Internet 221. Servers 222a-222m are also connected to the Internet 221 through respective communication links. Servers 222a-222m include information and databases accessible by the user devices 220a-220n. In one embodiment of the present invention, databases for storing product information reside on at least one of the servers 222a-222m and are accessible by users using one or more of the user devices 220a-220n to obtain product information.

In an alternative embodiment of the present invention, the product databases are stored on a Global Distribution System 240. Product information, including current prices and availability, is gathered from product providers and stored on the Global Distribution System 240. The Global Distribution System 240 is accessible by at least one of the servers 222a-222m through the Internet.

In yet another alternative embodiment, the product databases are stored on computers of the individual product providers. Each of the product databases stored on computers of the individual product providers contains product information, including current prices and availability. The databases stored on computers of the individual product providers are accessible by at least one of the servers 222a-222m through the Internet.

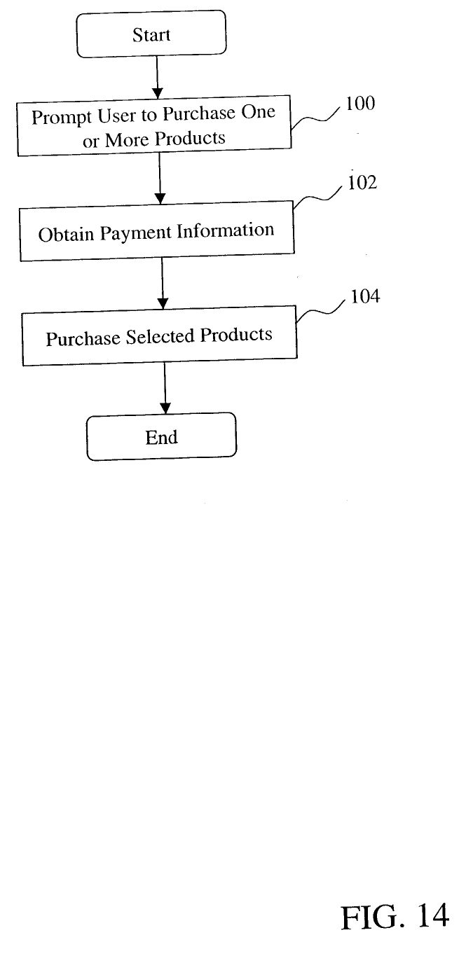

In one embodiment of the present invention, each of the user devices 220a-220n typically includes a central processing unit (CPU) 223 for processing and managing data; and a keyboard 224 and a mouse 225 for inputting data. A main memory 227 such as a Random Access Memory (RAM), a video memory 228 for storing image data, and a mass storage device 231 such as a hard disk for storing data and programs are also included in a typical user device. Video data from the video memory 228 is displayed on a Display screen 230 by a display adapter 229 under the control of the CPU 223. A communication device 232, such as a modem, provides access to the Internet 221. Optionally, one or more of user devices 220a-220n may be connected to a local network 234. An Input/Output (I/O) device 226 reads data from various data sources and outputs data to various data destinations. Servers (hosts) 222a-222m are also computers and typically have architecture similar to the architecture of user devices 220a-220n. Generally, servers differ from the user devices in that servers can handle multiple telecommunications connections at one time. Usually, servers have more storage and memory capabilities, and higher speed processors. Some server (host) systems may actually be several computers linked together, with each handling incoming web page requests. In one embodiment, each server 222a-222m has a storage medium, such as a hard disk, a CD drive, or a DVD for loading computer software. When software such as the software responsible for executing the processes in FIGS. 1 and 3 to 14 is loaded on the server 222a, an off-the-shelf web management software or load balancing software may distribute the different modules of the software to different servers 222a-222m. A server may utilize an operating system such as DOS, Microsoft Windows, or Linux. The server may use off the shelf, or open source software to generate and serve web pages. In an embodiment, the server uses Apache server software to generate and serve web pages. The page generating software generates web pages that have, for example, hypertext markup language (HTML) and Javascript components. Additionally, the server may be protected from unauthorized access by the use of a firewall, such as one produced by Checkpoint.

Therefore, in one embodiment, the computer program responsible for executing the present invention resides on one or more servers. Databases to carry out the processes of FIGS. 1 and 3 to 14 may be created, maintained and edited in many different types of database software including Access, FoxPro, and Oracle. In one embodiment of the present invention the database software is made by Oracle.

An exemplary web site location 235 is shown on server 222a in FIG. 2. The web site 235 is the user interface for accessing the data described below. The web site 235 has a unique address that is used by the users to access server 222a (in this example) and the web site location on the server 222a. The computer software for executing the processes of the present invention may also reside on the web site 236.

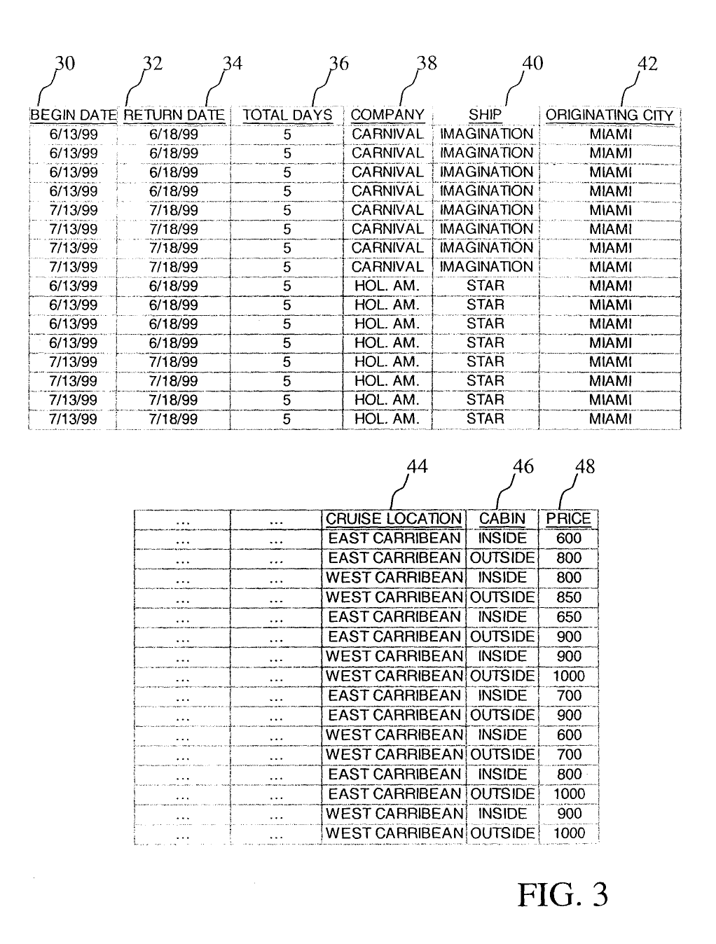

FIG. 3 shows an exemplary product database for cruises. An exemplary cruise database contains a cruise begin date 30, a cruise return date 32, a duration 34, a cruise line's name 36, a cruise ship's name 38, an originating location 40, ports of call 42, a cruise location 44, a cabin class 46, and a price 48.

In an embodiment, the cruise information database may contain additional information, such as whether the cruise is for single people, whether the cruise has formal dining, whether there are excursions, and additional ports of call. The cruise information database may also contain several additional price fields containing discount information corresponding to certain qualifications, such as the age of the traveler and membership in a travel organization.

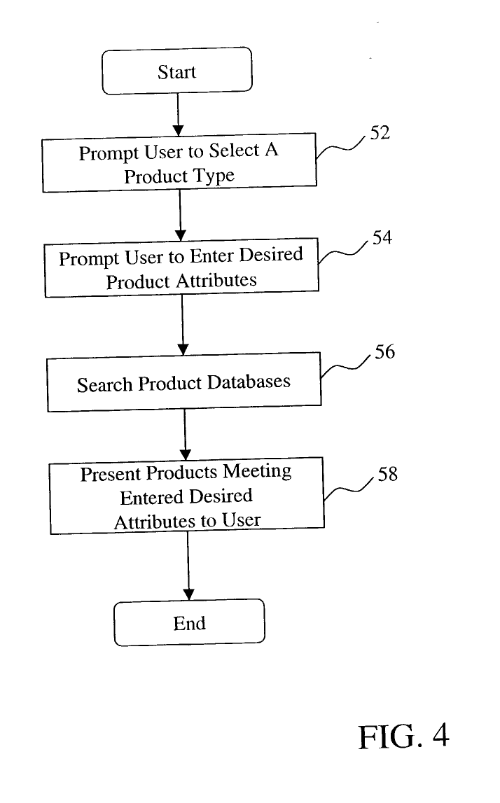

As shown in FIG. 4, when a user, using a user device, accesses the server, the server generates a user interface prompting the user to enter information. Initially, the user is prompted to select a type of product that they wish to purchase, box 52. In an exemplary embodiment, the user is prompted to select from travel products such as cruise tickets or airline tickets and electronic products, such televisions or digital cameras. In alternative embodiments, users may be prompted to choose from many additional types of products.

Depending on the type of product selected by the user, the user is prompted to enter desired product attributes, box 54. For example, if the user selects cruises as their desired travel product, then the user is prompted to enter one or more specific attributes regarding their preferred cruise. For example, the user is prompted to enter a cruise begin date, a cruise line's name, and a cruise destination.

The user may also be prompted to enter additional desired cruise attributes such as an originating city, a preferred cruise length, a preferred cabin type, such as inside stateroom, outside stateroom, or suite. The user may also be prompted to enter a desired price for the cruise. In another embodiment, the user is prompted to enter the type of facilities that the user would like on the ship and in the ports of call.

In an embodiment, once the consumer has entered desired product attributes, the processor searches the product databases for products that meet the criteria entered by the user, box 56. Additionally, some product information may be contained in databases kept by individual product providers. Queries are submitted to the individual product providers based upon user entered information. The information returned by the individual travel product providers may be further filtered by the server.

Following the search, product information corresponding to the product attributes entered by the user is presented to the user, box 58. For example, if the user requested cruise information and entered desired cruise attributes, the processor returns cruise itineraries corresponding to the desired cruise attributes. If a large number of travel products having the attributes entered by the user are found, such as over 100, the user is prompted to enter additional attributes to narrow the travel products further. If no travel products meeting the attributes entered by the user are found, the user is prompted to change one or more attributes.

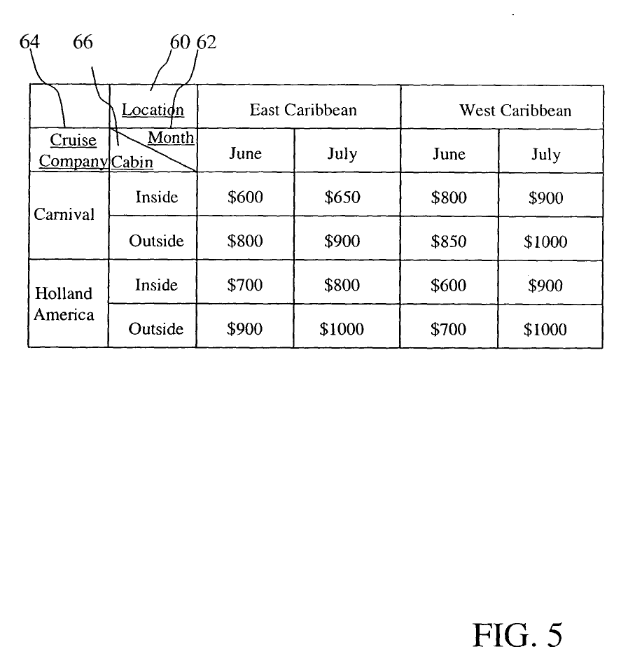

As shown in FIG. 5, product information is presented to a user in a multidimensional display. All of the information contained in the database of FIG. 3, may be presented to a user in the display of FIG. 5. Such a display simplifies the data for a user, so that the user can quickly select from many different products.

In an exemplary embodiment, as shown in FIG. 5, the product information is displayed in a multidimensional table of cells. The table has an x-axis and a y-axis, with rows along the x-axis and columns along the y-axis. For reference purposes, the table has a top, with a first row being at the top, and a left side, with a first column being at the left side.

The table is organized by defining product attributes along the x-axis and the y-axis of the table. Each of the x-axis and the y-axis consist of one or more product attributes. Specific products are positioned in certain rows and columns of the table because the product has the attributes defined for those rows and columns.

In an exemplary embodiment with two product attributes defined along the x-axis and two product attributes defined along the y-axis, a first product attribute is defined in the first row. A first row label 60 indicates the product attribute of the first row. In the exemplary table of FIG. 5, the first product attribute is cruise location, namely the East Carribean and West Carribean. Cruise products listed in a column under a first row cell defining a specific location travel to that specific location.

A second product attribute is defined in a second row adjacent to the first row. A second row label 62 indicates the product attribute of the first row. In the exemplary table of FIG. 5, the second attribute is the month of the cruise, namely June or July.

A third product attribute is defined in the first column. In an embodiment, a first column label 64 indicates the product attribute of the first column. In the exemplary table of FIG. 5, the third product attribute is the cruise company, namely Carnival or Holland America.

A fourth product attribute is defined in a second column adjacent to the first column. In an embodiment, a second column label 66 informs the user of the product attribute of the second column. In the exemplary table of FIG. 5, the fourth product attribute is the cabin class, namely whether the cabin is inside or outside.

The products are sorted so that an additional attribute of each product, such as the price, is then displayed in the remaining cells of the table. In the exemplary table of FIG. 5, the products are sorted and the prices displayed so that by looking at a price, the user can quickly tell the location, month, cruise company and cabin type of the cruise.

It will be appreciated by those skilled in the art that the table may be organized on fewer product attributes. Likewise, it will be appreciated by those skilled in the art that products may be sorted based on additional product attributes by defining additional product attributes along the x-axis or the y-axis.

The defined product attributes along the x-axis and the y-axis of the table may be chosen by the user or by the server. In an embodiment, the user chooses the x-axis and the y-axis attributes according to their preferences in making a price comparison. The user may choose the x-axis and the y-axis product attributes by answering questions submitted to them by the server, by selecting attributes from a pull-down menu, and by selecting radio buttons.

In another embodiment of the present invention, certain cells in the table are color coded to indicate significance. For example, some cells may be given a red background color to show a large price decrease from previous prices, and some cells may be given a green background to show special sales from product providers.

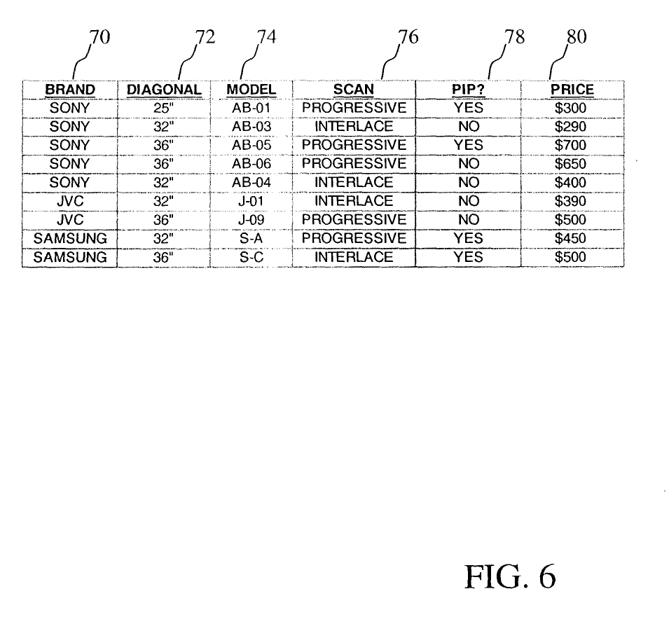

Although the above example is directed to cruise products, the present invention may be used for other products having multiple attributes that users would like to compare to select a particular product for purchase. In an embodiment, the present invention is used to assist users in buying televisions. As shown in FIG. 6, a television database may contain many records. Each record has product attributes of a specific television. The attributes in the database may include, for example, the brand 70, the diagonal size 72, the model number 74, whether the scan is progressive or interlaced 76, whether there is picture in picture tuning 78, and the price 80.

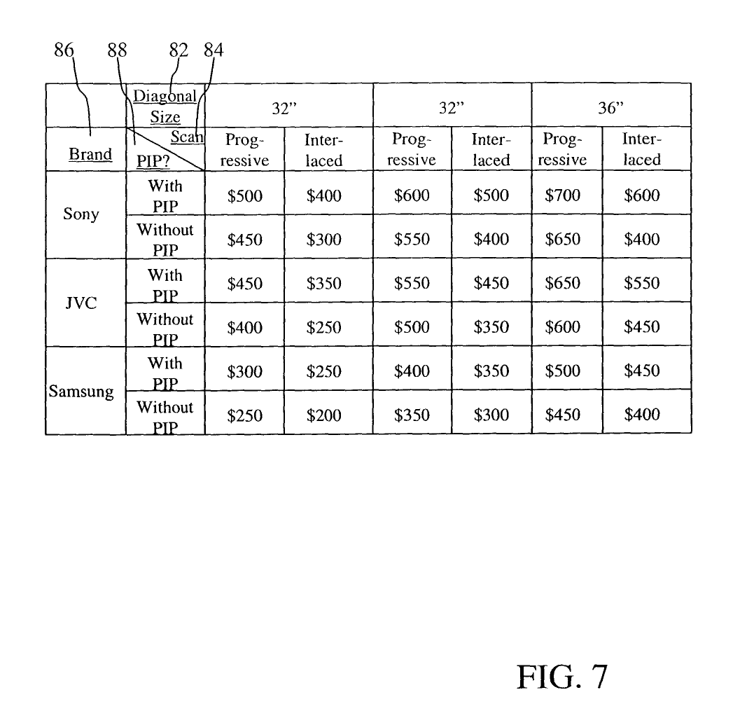

FIG. 7 is a multi-dimensional display of televisions according to an exemplary embodiment of the present invention. The first row 82 defines diagonal size. The second row 84 defines whether the scan is progressive or interlaced. The first column 86 defines the brand of the television. The second column 88 defines whether or not the television has picture in picture tuning. The prices of televisions having the defined attributes are provided in the remaining cells. A user viewing the table of FIG. 7 can quickly find out the price of a television having four different attributes.

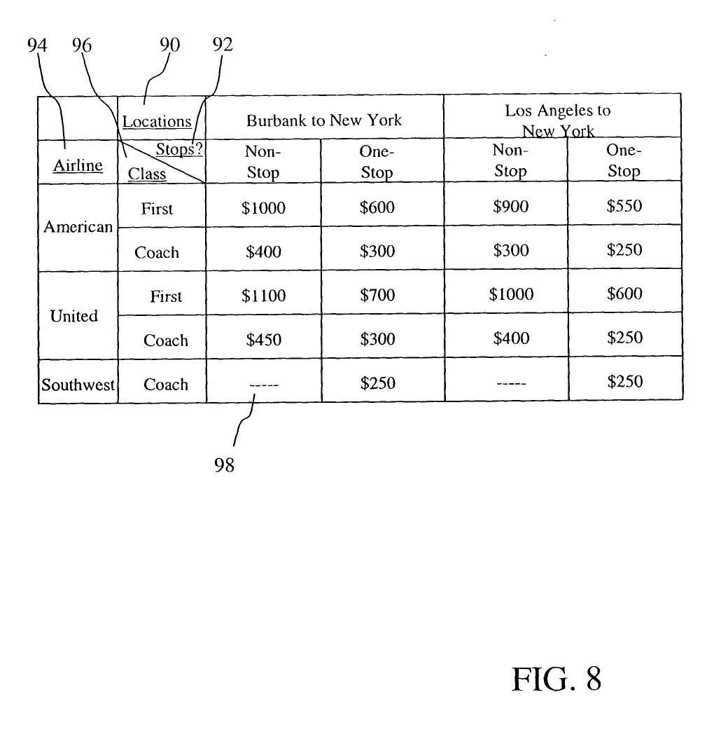

FIG. 8 is a multi-dimensional display of airline tickets according to an exemplary embodiment of the present invention. The first row 90 defines the origin and destination of the flight. The second row 92 defines the number of stops the flight has. The first column 94 defines the airline. The second column 96 defines the seat class. The prices of airline tickets having the defined attributes are provided in the remaining cells. A user viewing the table of FIG. 8 can quickly find out the price of an airline ticket having four different attributes. As shown in FIG. 8, an indicator 98 may be placed in cells where no product meets the particular combination of the defined parameters.

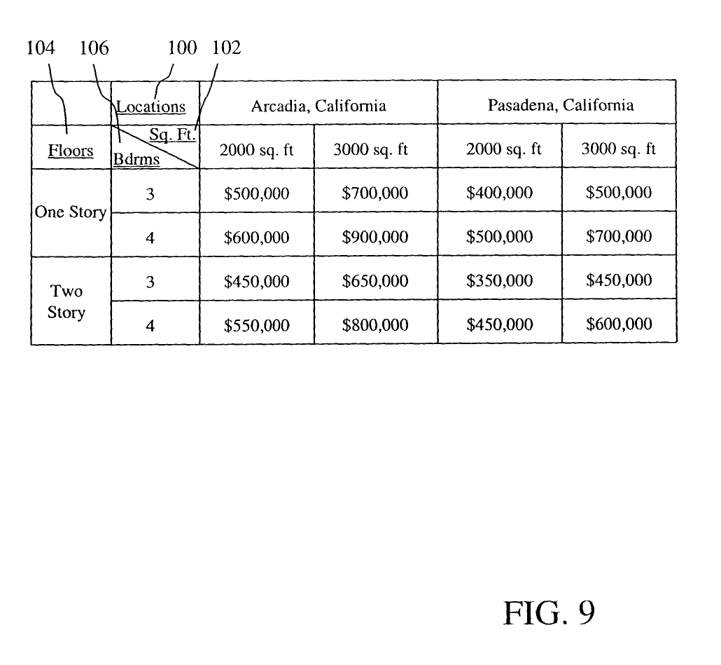

FIG. 9 is a multi-dimensional display of homes for sale according to an exemplary embodiment of the present invention. The first row 100 defines the location of the home. The second row 102 defines the square footage of the home. The first column 104 defines the number of floors the home contains. The second column 106 defines the number of bedrooms the home contains. The prices of houses having the defined attributes are provided in the remaining cells. A user viewing the table of FIG. 9 can quickly compare the costs of houses having particular attributes in two different locations.

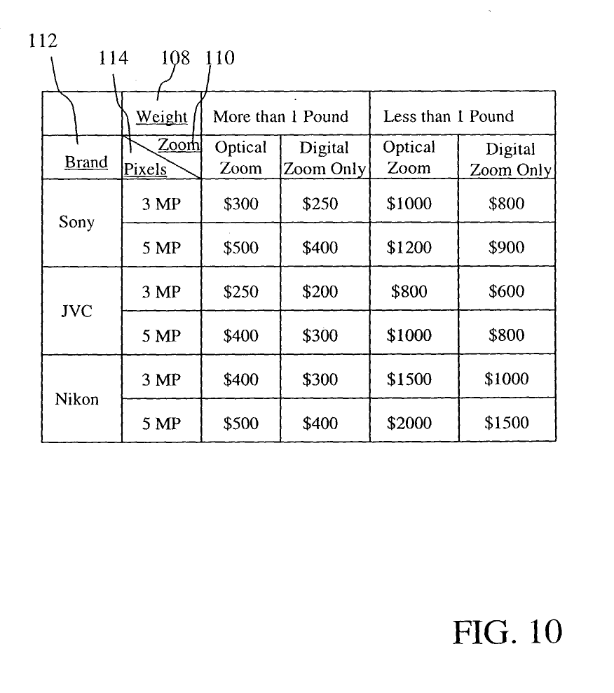

FIG. 10 is a multi-dimensional display of digital cameras for sale according to an exemplary embodiment of the present invention. The first row 108 defines the weight of the camera, namely whether the camera is more or less than one pound. The second row 110 defines whether the camera has an optical or a digital zoom. The first column 112 defines the brand of the camera. The second column 114 defines the number of pixels that the camera has. The prices of digital cameras having the defined attributes are provided in the remaining cells.

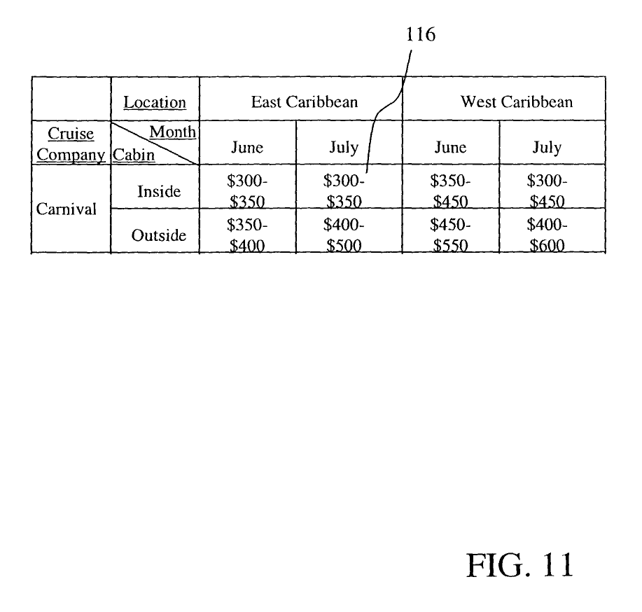

Multiple products with different prices may be found having a particular combination of the defined attributes. In an embodiment, shown in FIG. 11, a range of the different prices 116 is displayed in the cells of the multi-dimensional display. In an alternative embodiment, the lowest price is displayed. In yet another embodiment, an average of all of the products having the particular combination of attributes is displayed.

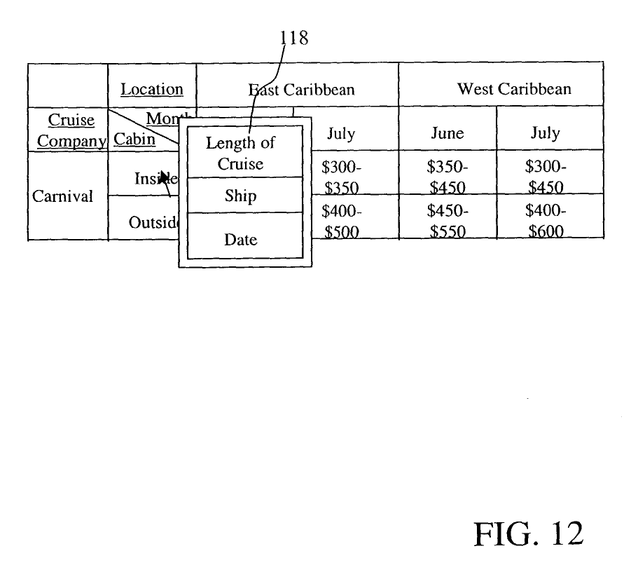

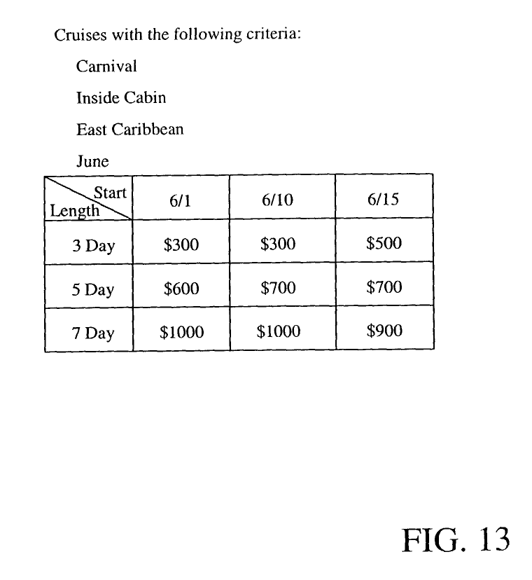

In another embodiment, when multiple products with different prices are found having a particular combination of the defined attributes, the user has the choice to look into additional parameters. As shown in FIG. 12, when the user selects a cell representative of multiple products, a menu 118 is displayed that allows the user to select additional product attributes for sorting. Once the user has made a selection of an additional product attribute to sort by, an expanded table is displayed. The user may keep selecting additional product attributes to sort by until each cell defines a unique product. FIG. 13 is an example of an expanded table showing additional product attributes.

In an additional embodiment, the user is prompted to purchase one or more products from the multi-dimensional display, box 100. If the user elects to purchase one or more products, then the user is prompted to enter payment information, box 102. If the user has an account stored on the server with payment information, then the user's payment information is automatically obtained. Once payment information is obtained, the server purchases the product from the product vendor, box 104.

In an additional embodiment of the present invention, the product data is downloaded to a user device. The server searches the user device for table generating software, such as Microsoft Excel and Microsoft Word. If the server locates the necessary software on the user device, then the server sends the product data and a program, such as a macro routine, to the user device. Once the program is sent to the user device, the program opens up the necessary software and allows the computer to manipulate the data on the user device. The user is returned to the server when necessary, such as when the user selects options that require more data, the user has finished comparing products, or the user wishes to purchase a product.

The preceding description has been presented with reference to presently preferred embodiments of the invention. Workers skilled in the art and technology to which this invention pertains will appreciate that alterations and changes in the described structure may be practiced without meaningfully departing from the principle, spirit and scope of this invention. Accordingly, the foregoing description should not be read as pertaining only to the precise system and method described and illustrated in the accompanying drawings, but rather should be read consistent with and as support for the following claims, which are to have their fullest and fairest scope.

What is claimed is:

1. A method utilizing a computer for locating travel products for a user comprising:
receiving, by the computer, desired travel product attributes from a user;
searching a database of travel products, using a computer, to select desired travel products using the desired travel product attributes received from a user; and
displaying data regarding desired travel products to a user in a multi-dimensional table with at least two axes, wherein a first axis of the multi-dimensional table comprises different values of at least one parameter and a second axis of the multi-dimensional table is comprised of different values of a plurality of parameters where at least one such parameter is determined by at least one of the desired travel product attributes.

2. The method of claim 1 wherein the first axis of the multi-dimensional table is comprised of different values of a plurality of parameters where at least one such parameter is determined by at least one of the desired product attributes.

3. The method of claim 1 further comprising:
receiving, by the computer, additional product attributes from a user; and
determining the value of at least one of the parameters of at least one of the first axis and the second axis by at least one the additional product attributes.

4. The method of claim 1 further comprising:
receiving, by the computer, additional product attributes from the user after displaying data regarding desired travel products to a user in the multi-dimensional table with at least two axes; and
displaying data regarding desired travel products to a user in a new multi-dimensional table with at least two axes, wherein a first axis of the new multi-dimensional table comprises different values of at least one parameter and a second axis of the new multi-dimensional table is comprised of different values of a plurality of parameters where at least one such parameter is determined by at least one of the desired travel product attributes, and wherein at least one of the parameters of at least one of the first axis and the second axis is determined by at least one the additional product attributes.

5. The method of claim 1 further comprising:
receiving, by the computer, of personal information from the user.

6. The method of claim 5, wherein the personal information received from a user contains at least one of an address, a telephone number, a user's age and information about a user's membership in travel organizations.

7. The method of claim 1, wherein receiving the desired travel product attributes from the user further comprises receiving from the user a travel product type and attributes of the selected travel product type.

8. The method of claim 7, wherein receiving the desired travel product attributes from the user further comprises receiving from the user at least one of the group consisting of a travel product provider, a date that the travel product is desired, and a price.

9. The method of claim 8, wherein receiving the desired travel product attributes from the user further comprises receiving from the user a travel product offered by a selected travel product provider.

10. A computer for locating travel products for a user wherein the computer is configured to receive desired travel product attributes from a user, search a database for travel products using a computer to select desired travel products using the desired travel product attributes received from the user, and create data for transmission to the user representative of a display of data regarding desired travel products in a multi-dimensional table with at least two axes, wherein a first axis of the multi-dimensional table comprises different values of at least one parameter and a second axis of the multi-dimensional table is comprised of different values of a plurality of parameters wherein at least one such parameter is determined by at least one of the desired travel product attributes.

11. The computer of claim 10 wherein the first axis of the multi-dimensional table is comprised of different values of a plurality of parameters where at least one such parameter is determined by at least one of the desired product attributes.

12. The computer of claim 10 wherein the computer is configured to receive additional product attributes from a user and is further configured such that at least one of the parameters of at least one of the first axis and the second axis is determined by at least one the additional product attributes.

13. The computer of claim 10 wherein the computer is configured to receive personal information from a user.

14. The computer of claim 13 wherein the personal information received from a user contains at least one of an address, a telephone number, a user's age and information about a user's membership in travel organizations.

15. The computer of claim 10 wherein the computer is configured to receive from a user the desired travel product attributes comprising a travel product type and attributes of the selected travel product type.

16. The computer of claim 15 wherein the computer is configured to receive from a user the desired travel product attributes comprising at least one of the group consisting of a travel product provider, a date that the travel product is desired, and a price.

17. The computer of claim 16 wherein the computer is configured to receive from a user the desired travel product attributes further comprising a travel product offered by a selected travel product provider.
